(19) United States
(12) Patent Application Publication
(10) Pub. No.: US 2026/0238268 A1
(43) Pub. Date: Aug. 13, 2026

(54) Rx Port Configuration Message for Efficient Beamforming

(71) Applicant: Parallel Wireless, Inc., Nashua, NH (US)

(72) Inventors: Yaniv Kaver, Kefar Sava (IL); Ory Eger, Tel Aviv (IL)

(21) Appl. No.: 19/050,014

(22) Filed: Feb. 10, 2025

Related U.S. Application Data
(60) Provisional application No. 63/607,970, filed on Dec. 8, 2023.

(51) Int. Cl. H04B 7/06

(52) U.S. Cl. CPC H04B 7/0617; H04B 7/0634

(57) ABSTRACT

A method is disclosed for optimizing downlink beamforming in a massive MIMO transceiver system, comprising: transmitting, by a next-generation Node B (gNb), a Rx Port Configuration Message (RPCM) to a User Equipment (UE), The RPCM may include instructions for the UE to configure its receive (Rx) antennas to achieve a desired signal-to-interference ratio; receiving, by the UE, the RPCM from the gNb; configuring, by the UE, its Rx antennas based on the instructions provided in the RPCM; performing, by the gNb, downlink beamforming based on the configuration of the UE's Rx antennas as indicated in the RPCM; and achieving, by the system, improved spectral efficiency and overall system performance through the directed use of each of the UE's Rx antennas, thereby improving Sounding Reference Signal (SRS) channel estimation, simplifying beamforming weight computation at the base station side, and enhancing cell throughput.

### CROSS-REFERENCE TO RELATED APPLICATIONS

The present application claims priority under 35 U.S.C. § 119(e) to U.S. Provisional Patent App. No. 63/607,970, having the same title as the present application and filed Dec. 8, 2023, which is hereby incorporated by reference in its entirety for all purposes. Additionally, the present application incorporates by reference U.S. Pat. App. Nos. 63/499239, 63/493599, 63/485790, 63/487245, and 63/484485 in their entirety for all purposes. In addition, U.S. Pat. App. Nos. US20230269633A1 and US20230291646A1 are hereby incorporated by reference in their entirety for all purposes.

### BACKGROUND

Massive Multiple-Input Multiple-Output (MIMO) transceivers represent a significant advancement in wireless communication technology, aimed at enhancing spectral efficiency, throughput, and coverage. This is achieved by increasing the number of antennas and employing large adaptive antenna arrays. The core principle behind Massive MIMO is the utilization of a large number of antennas at the base station and a plurality of antennas at the user equipment (UE) as well, which allows for the simultaneous transmission and reception of multiple data streams. This multiplicity of antennas enables the system to exploit spatial diversity and spatial multiplexing, thereby improving the overall system capacity. Adaptive antenna arrays play a crucial role in this technology by dynamically adjusting the beamforming patterns to optimize signal strength and reduce interference. This adaptability is facilitated through advanced signal processing algorithms that continuously analyze the wireless environment and adjust the antenna parameters accordingly. The increased number of antennas also contributes to enhanced coverage, as the system can focus the transmission power in specific directions, reaching users at greater distances with higher reliability. Furthermore, the use of large antenna arrays allows for more precise control over the spatial domain, which is essential for mitigating the effects of multipath propagation and improving the signal-to-noise ratio. As a result, Massive MIMO transceivers are capable of delivering higher data rates and more reliable connections, making them a critical component in the evolution of next-generation wireless networks. This technology is particularly relevant in the context of 5G and beyond, where the demand for high-speed, low-latency communication is ever-increasing. By leveraging the benefits of Massive MIMO, network operators can meet these demands while efficiently utilizing the available spectrum resources.

### SUMMARY

In a first embodiment, a method is disclosed for optimizing downlink beamforming in a massive MIMO transceiver system, comprising: transmitting, by a next-generation Node B (gNb), a Rx Port Configuration Message (RPCM) to a User Equipment (UE), The RPCM may include instructions for the UE to configure its receive (Rx) antennas to achieve a desired signal-to-interference ratio; receiving, by the UE, the RPCM from the gNb; configuring, by the UE, its Rx antennas based on the instructions provided in the RPCM; performing, by the gNb, downlink beamforming based on the configuration of the UE's Rx antennas as indicated in the RPCM; and achieving, by the system, improved spectral efficiency and overall system performance through the directed use of each of the UE's Rx antennas, thereby improving Sounding Reference Signal (SRS) channel estimation, simplifying beamforming weight computation at the base station side, and enhancing cell throughput.

The method may further comprise Rx antenna configuration for a UE that does not support full reciprocity for sounding signal transmission. The method may further comprise performing beamforming weight computation at the gNB using a Zero Forcing (ZF) precoder for interference cancellation at all active receive antennas of the UE. The RPCM may include at least one of an indication of antenna ports to use, an index to a predefined weight matrix, and an actual weights matrix.

In a second embodiment, a system is disclosed for optimizing downlink beamforming in a massive MIMO transceiver system, comprising: a next-generation Node B (gNb), the gNB The method may further comprise a processor and a memory, the memory including instructions which, when executed on the processor at the gNB, cause the gNB to perform steps including: performing beamforming weight computation using a User Equipment (UE) Sounding Reference Signal (SRS) for a plurality of UE receive (Rx) antennas at the UE; transmitting a Rx Port Configuration Message (RPCM) to the UE, The RPCM may include instructions on how the UE should configure the plurality of UE receive (Rx) antennas to achieve a desired signal-to-interference ratio; and performing downlink beamforming based on the configuration of the UE's Rx antennas as indicated in the RPCM, thereby achieving, by the system, improved spectral efficiency and overall system performance through the use of the plurality of UE Rx antennas at the UE.

The steps may further comprise transmitting a RPCM message with Rx antenna configuration for a UE that does not support full reciprocity for sounding signal transmission. The steps may further comprise performing beamforming weight computation at the gNB using a Zero Forcing (ZF) precoder for interference cancellation at all active receive antennas of the UE. The RPCM may include at least one of an indication of antenna ports to use, an index to a predefined weight matrix, and an actual weights matrix. The steps may further comprise maintaining backward compatibility using Sounding Reference Signal (SRS) messaging with a second UE without RPCM compatibility.

In a third embodiment, a system is disclosed for optimizing downlink beamforming in a massive MIMO transceiver system, comprising: a user equipment (UE), the UE The method may further comprise a processor and a memory, the memory including instructions which, when executed on the processor at the UE, cause the UE to perform steps including: receiving, from a next-generation Node B (gNb), a Rx Port Configuration Message (RPCM), The RPCM may include instructions on how the UE should configure each of a plurality of receive (Rx) antennas to achieve a desired signal-to-interference ratio; and configuring each of the plurality of Rx antennas of the UE based on the instructions provided in the RPCM; thereby improving Sounding Reference Signal (SRS) channel estimation, simplifying beamforming weight computation at the base station side, and enhancing cell throughput.

The steps may further comprise receiving an RPCM message at the UE with an Rx antenna configuration for a UE that does not support full reciprocity for sounding signal transmission. The steps may further comprise receiving an RPCM message generated using a Zero Forcing (ZF) precoder for interference cancellation at all active receive antennas of the UE. The RPCM may include at least one of an indication of antenna ports to use, an index to a predefined weight matrix, and an actual weights matrix.

### BRIEF DESCRIPTION OF THE DRAWINGS

FIG. 1 is a flow diagram showing a SRS between a gNB and one or more UEs, in accordance with the prior art.

FIG. 2 is a schematic diagram showing beamforming from a gNB, in accordance with the prior art.

FIG. 3 is a schematic diagram showing beamforming at a UE, in accordance with the prior art.

FIG. 4 is a flow diagram showing a SRS and an RPCM between a gNB and one or more UEs, in accordance with some embodiments.

FIG. 5 is a schematic diagram showing beamforming from a gNB, in accordance with some embodiments.

FIG. 6 is a schematic diagram showing beamforming at a UE, in accordance with some embodiments.

FIG. 7 is a schematic diagram of a multi-radio access technology (multi-RAT) ORAN network architecture, in accordance with some embodiments.

FIG. 8 is a schematic diagram of an ORAN-compatible network architecture, in accordance with some embodiments.

### DETAILED DESCRIPTION

The present disclosure discusses a new approach to improve beamforming in massive MIMO transceivers at the gNb. The problem is defined as the challenge of performing optimal downlink beamforming when the UE has multiple antenna ports, which can reduce spectral efficiency. The proposed enhancement is the introduction of a new Rx Port Configuration Message (RPCM) to be sent from the gNb to the UE. The RPCM message will guide the UE on how to use its Rx antennas to achieve the best signal-to-interference ratio. Additionally, we highlight the importance of algorithms like zero forcing, which utilize these arrays to beamform the signal effectively. For example, the antenna arrays can enhance the likelihood that a beam relevant to a specific UE will reach it with maximal power, and that beams which are not relevant for the specific UE are effectively reduced in power or nulled.

In some embodiments, the present disclosure outlines several formats for the RPCM, including an indication of which ports to use and an index to a predefined weight matrix or the actual weights matrix. The benefits of this mechanism include enabling accurate SRS channel estimation based on MU-MIMO for UEs that don't support full reciprocity, simplifying BF weight computation at the BS side, and potentially leading to better performance and higher cell throughput.

Finally, the presentation discusses the protocol aspects and patent detectability, suggesting that the new Rx Port Matrix configuration could be conveyed to the UEs via dedicated fields of the DCI, as described in 3GPP 38.214, hereby incorporated by reference.

This disclosure focuses on the role of massive MIMO transceivers at the gNb in enhancing spectral efficiency, throughput, and coverage. This improvement is achieved by significantly increasing the number of antennas and utilizing large adaptive antenna arrays. Algorithms such as zero forcing leverage these arrays to beamform the signal effectively.

In some embodiments, the present disclosure continues by defining the problem associated with performing optimal downlink beamforming when the User Equipment (UE) has multiple antenna ports. This situation poses a challenge because accounting for all the UE's ports can be difficult, leading to reduced spectral efficiency.

In some embodiments, the present disclosure continues by defining the problem associated with performing optimal downlink beamforming when the User Equipment (UE) has multiple antenna ports. This situation poses a challenge because accounting for all the UE's ports can be difficult, leading to reduced spectral efficiency. In massive MIMO systems, the gNb (next-generation Node B) needs to learn the channel from all the UE's Rx (receive) antennas to perform optimal downlink beamforming. In Time Division Duplex (TDD) systems, reciprocity can be assumed, meaning that the gNb can obtain the channel matrix by measuring the uplink Sounding Reference Signal (SRS) sent by the UE.

The 3GPP TS 36.211 LTE standard, hereby incorporated by reference, defines antenna ports for uplink and downlink. An antenna port is generally used as a generic term for signal transmission under identical channel conditions. For each LTE operating mode in the downlink direction for which an independent channel is assumed, a separate logical antenna port is defined. LTE symbols that are transmitted via identical antenna ports are subject to the same channel conditions. In order to determine the characteristic channel for an antenna port, a UE must carry out a separate channel estimation for each antenna port. Separate reference signals (sounding reference signals or SRS) that are suitable for estimating the respective channel are defined in the LTE standard for each antenna port.

However, when the UE has multiple antenna ports, it becomes challenging to perform beamforming that accounts for all its ports. This challenge arises because the gNb needs to accurately estimate the channel for each of the UE's Rx antennas, which can be complex and resource-intensive. Also, not all UEs are able to support SRS that allow for estimation for each of the UE's Rx ports. As a result, the spectral efficiency of the system is reduced, leading to suboptimal performance.

In some embodiments, the present disclosure highlights that the problem is particularly pronounced in scenarios where the UE has a large number of antenna ports. In such cases, the gNb must perform extensive calculations to determine the optimal beamforming weights for each port, which can be computationally expensive and time-consuming. Additionally, the gNb must ensure that the beamforming weights are updated regularly to account for changes in the channel conditions, further increasing the complexity of the process. This problem is exacerbated in environments with high mobility, where the channel conditions can change rapidly, requiring frequent updates to the beamforming weights.

There is a need for a solution that can simplify the process of performing optimal downlink beamforming in scenarios where the UE has multiple antenna ports. Such a solution would help improve the spectral efficiency of the system, leading to better performance and higher throughput. The proposed solution aims to address this challenge by introducing a new Rx Port Configuration Message (RPCM) that can guide the UE on how to use its Rx antennas to achieve the best signal-to-interference ratio.

In some embodiments, the present disclosure introduces the proposed solution to the problem of performing optimal downlink beamforming when the User Equipment (UE) has multiple antenna ports. The solution involves defining a new Rx Port Configuration Message (RPCM) to be sent from the gNb (next-generation Node B) to the UE. This message will guide the UE on how to use its Rx antennas to achieve the best signal-to-interference ratio. By providing specific instructions on which ports to use and potentially including an index to a predefined weight matrix or the actual weights matrix, the RPCM aims to simplify the process of beamforming for the gNb. This approach is expected to improve spectral efficiency and overall system performance by ensuring that the UE's Rx antennas are utilized optimally.

In some embodiments, the present disclosure introduces the proposed solution to the problem of performing optimal downlink beamforming when the User Equipment (UE) has multiple antenna ports. The solution involves defining a new Rx Port Configuration Message (RPCM) to be sent from the gNb (next-generation Node B) to the UE. This message will guide the UE on how to use its Rx antennas to achieve the best signal-to-interference ratio. By providing specific instructions on which ports to use and potentially including an index to a predefined weight matrix or the actual weights matrix, the RPCM aims to simplify the process of beamforming for the gNb. This approach is expected to improve spectral efficiency and overall system performance by ensuring that the UE's Rx antennas are utilized optimally.

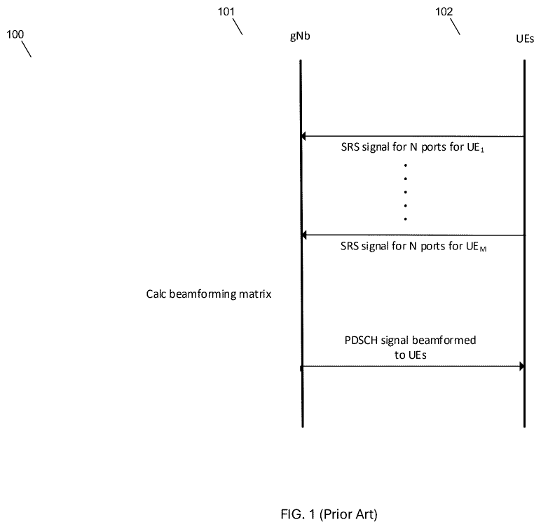

FIG. 1 is a flow diagram 100 showing a SRS between a gNB 101 and one or more UEs 102, in accordance with the prior art. For optimal downlink beamforming, the gNb needs to learn the channel, ideally from all UEs' Rx antennas, and signaling is known for this process; see, e.g., 3GPP TR 38.901, 3GPP TS 38.211, 3GPP TS 38.300, 3GPP TS 38.331, each hereby incorporated by reference in its entirety. Downlink Control Information (DCI) is further described in 3GPP TS 38.214, which is hereby incorporated by reference in its entirety for all purposes. In certain systems, notably TDD, reciprocity can be assumed, allowing the gNb to calculate and thereby obtain the channel matrix by measuring the uplink sounding reference signal (SRS) signal, which is transmitted for each UE from the UE 102 to the gNB 101. Once the gNB calculates the beamforming matrix for each UE and channel, the PDSCH signal is constructed and beamformed to UEs. However, this advantageous flow does not apply to many scenarios.

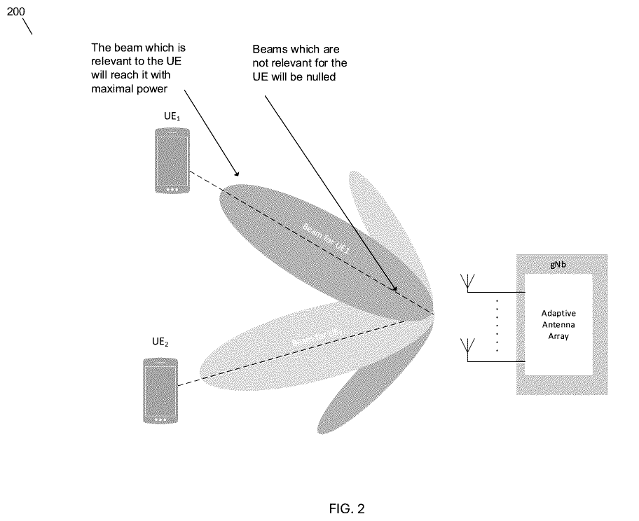

FIG. 2 is a schematic diagram showing beamforming from a gNB, in accordance with the prior art. Subsequent to calculating a beamforming matrix as referred to in FIG. 1, a gNB with adaptive antenna array can send different beams to UE 1 versus UE 2, by combining the signal for each UE with the calculated beamforming matrix specific to each UE. This results in the beam which is relevant to the UE being made to reach it with increased power and beams not relevant for the UE being nulled. In some instances, due to the physical limitations of radio transmission, a transmission for one UE may have a beam and one or more side lobes. The beamforming matrix is used to direct a beam at the UE and reduce the strength of the other beams.

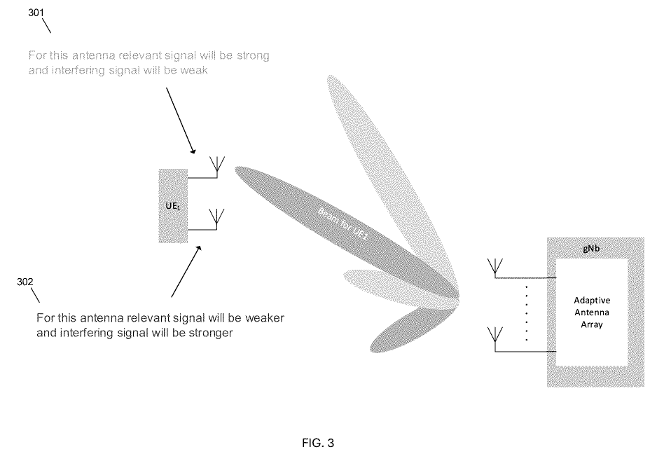

FIG. 3 is a schematic diagram showing beamforming at a UE with multiple antennas, in accordance with the prior art. When the UE has multiple antennas, beamforming using the prior art techniques, wherein a single beam is directed at the UE, may be less effective. This is because for one antenna at the UE, the relevant signal may be strong and interferers are weak, as intended, but at all other antennas at the UE, the interferers will be stronger and the relevant signal will be weaker, due to improperly optimizing for the single UE antenna.

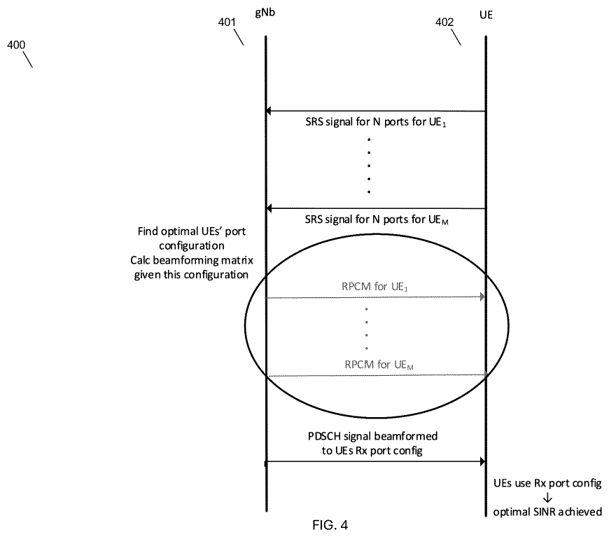

FIG. 4 introduces the proposed solution to the problem of performing optimal downlink beamforming when the User Equipment (UE) has multiple antenna ports and sends SRS signals for each of its N ports (some subset of 1 to M). The solution involves defining a new Rx Port Configuration Message (RPCM) to be sent from the gNb (next-generation Node B) to the UE. This message will guide the UE on how to use its Rx antennas to achieve the best signal-to-interference ratio. The gNB calculates the UE's optimal port configuration, calculates beamforming matrix given this configuration, and creates one RPCM per UE antenna port, and sends these RPCMs to the UE. Subsequent PDSCH signals are beamformed to this specific UE using the Rx port configuration, thereby improving SINR.

The RPCM can have several formats, including an indication of which ports to use out of the existing ports and an index to a predefined weight matrix or the actual weights matrix. This approach aims to simplify the process of beamforming for the gNb by providing specific instructions on how the UE should configure its Rx antennas. By doing so, the RPCM helps improve spectral efficiency and overall system performance by ensuring that the UE's Rx antennas are utilized optimally.

The benefits of this mechanism include enabling accurate SRS channel estimation based on MU-MIMO for UEs that do not support full reciprocity, simplifying BF weight computation at the BS side, and potentially leading to better performance and higher cell throughput. This mechanism is an optional feature and does not break backward compatibility with previous SRS usage. For example, a simple zero forcing precoder will suffice for interference cancellation at all active receive antennas, eliminating the need for additional channel matrix decomposition calculations. In certain scenarios, this approach enables better performance, leading to overall higher cell throughput.

In some embodiments, the RPCM will be conveyed to the UEs, and one method that can be chosen is sending this configuration over dedicated fields of the DCI (Downlink Control Information). In this case, these fields will be described in 3GPP 38.214. The detectability of the patent is straightforward as it will be part of the standard.

The Rx Port Configuration Message (RPCM) is sent from the gNb (next-generation Node B) to the User Equipment (UE) over the Downlink Control Information (DCI) interface, in some embodiments. This configuration is conveyed through dedicated fields within the DCI, as described in the 3 GPP 38.214 standard, in some embodiments.

In some embodiments, RPCM would be sent as needed to guide the UE on how to use its Rx antennas to achieve the best signal-to-interference ratio. The frequency of sending the RPCM would likely depend on various factors such as changes in channel conditions, mobility of the UE, and the need to update the beamforming configuration to maintain optimal performance.

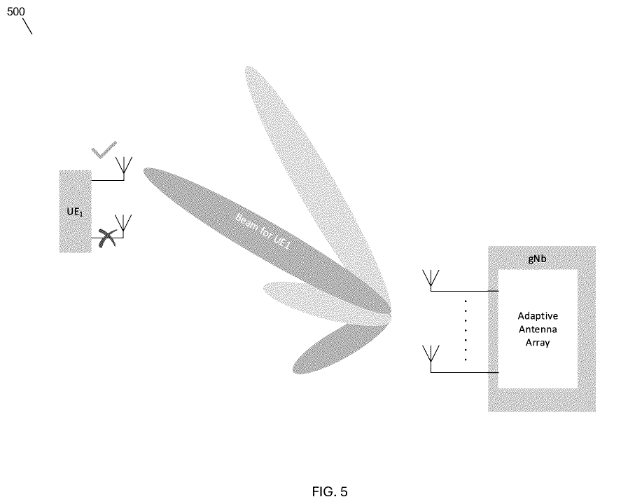

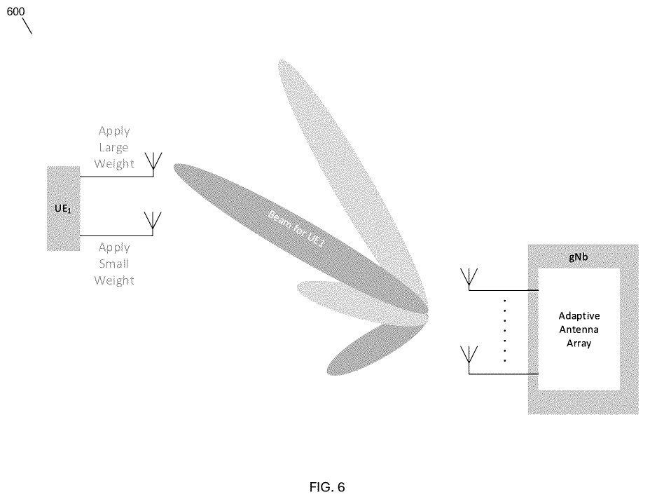

FIGS. 5 and 6 show the RPCM in operation. First, FIG. 5 shows the use of RPCM for a gNB and UE that each have multiple antennas and support RPCM. When RPCM is used, a strong beam based on the calculated beamforming matrix is sent to UE and the UE is directed to use only one of its two antennas, but in a way that improves SINR, e.g., over using the antennas equally or over a naive approach. More broadly, an indication of which antenna ports to use (one or more ports) out of the existing ports is sent in the RPCM, in some embodiments. FIG. 6 shows a similar scenario, wherein the UE is directed to use a large weight for one antenna and a small weight for another antenna, in a way that improves SINR, e.g., over using the antennas equally or over a naive approach. More broadly, an index to a predefined weight matrix, or the content of an actual weights matrix, may be sent in the RPCM, in some embodiments. These two embodiments may be mixed and matched for different UEs or for the same UE at different times, in some embodiments.

The Rx Port Configuration Message (RPCM) is originated at the gNb (next-generation Node B) rather than the User Equipment (UE) for several reasons.

Firstly, the gNb is responsible for managing the overall network and has a comprehensive view of the network conditions, including the channel state information (CSI) from all UEs. This allows the gNb to make informed decisions about beamforming and other network optimizations. In Time Division Duplex (TDD) systems, the gNb can obtain the channel matrix by measuring the uplink Sounding Reference Signal (SRS) sent by the UE. This reciprocity enables the gNb to accurately estimate the downlink channel based on the uplink measurements.

Secondly, the gNb has the computational resources and capabilities to perform complex calculations required for optimal beamforming. It can determine the best configuration for the UE's Rx antennas to achieve the highest signal-to-interference ratio. By sending the RPCM to the UE, the gNb can guide the UE on how to configure its antennas without requiring the UE to perform these calculations, which can be resource-intensive.

Additionally, the gNb can dynamically adjust the RPCM based on real-time network conditions and changes in the channel environment. This flexibility allows the gNb to continuously optimize the network performance and ensure that the UEs are always configured for optimal reception.

Originating the RPCM at the gNb ensures that the network can leverage its centralized control, computational power, and real-time adaptability to optimize beamforming and enhance spectral efficiency.

Various formats of the Rx Port Configuration Message (RPCM) can be sent from the gNb (next-generation Node B) to the User Equipment (UE). The RPCM can have several formats, including an indication of which ports to use out of the existing ports and an index to a predefined weight matrix or the actual weights matrix. This message is crucial for guiding the UE on how to use its Rx antennas to achieve the best signal-to-interference ratio.

The RPCM can be conveyed using bitmaps, octets, and a specific number of bits. Bitmaps are used to indicate which ports should be active, while octets and bits are used to represent the weight matrix or the index to the predefined weight matrix. The use of bitmaps allows for a compact representation of the port configuration, making it efficient to transmit over the air. The number of bits required for the RPCM depends on the number of ports and the complexity of the weight matrix. By using these formats, the gNb can efficiently communicate the optimal configuration to the UE, ensuring that the Rx antennas are utilized effectively.

We further discuss the applications and benefits of the proposed Rx Port Configuration Message (RPCM) mechanism. This mechanism enables accurate Sounding Reference Signal (SRS) channel estimation based on Multi-User Multiple Input Multiple Output (MU-MIMO) for User Equipment (UEs) that do not support full reciprocity, such as those unable to send a sounding signal through all their antennas. The RPCM is an optional feature that maintains backward compatibility with previous SRS usage.

The RPCM may also be sent in combination with the UE-specific reference signal (DMRS). The UE uses UE-specific RS for demodulation of the PDSCH and estimates the channel matrix multiplied by the beamforming antenna matrix. This allows for UE-specific beamforming precodings. This is available in LTE non-codebook based transmission modes (Rel. 8 and above), as well as in 5G.

One of the key benefits of the RPCM is that it simplifies the beamforming (BF) weight computation at the base station (BS) side. For example, a simple Zero Forcing (ZF) precoder can suffice for interference cancellation at all active receive antennas, eliminating the need for additional channel matrix decomposition calculations. This simplification can lead to better performance in certain scenarios, resulting in overall higher cell throughput. More users can be scheduled together for the same amount of base station antennas, enhancing the efficiency of the network.

In “Massive MIMO with Multi-Antenna Users: When are Additional User Antennas Beneficial?” by E. Bjönson, which is incorporated by reference, the benefits of using additional user antennas in massive MIMO systems are supported. The study highlights that the RPCM mechanism can lead to improved performance and higher throughput by optimizing the use of the UE's Rx antennas.

The RPCM mechanism offers significant advantages in terms of simplifying BF weight computation, maintaining backward compatibility, and enhancing network performance and efficiency.

We further discuss the protocol aspects and patent detectability of the proposed Rx Port Configuration Message (RPCM) mechanism. The newly suggested Rx Port Matrix configuration will need to be conveyed to the User Equipment (UEs), and one method that can be chosen is sending this configuration over dedicated fields of the Downlink Control Information (DCI). In this case, these fields will be described in the 3 GPP 38.214 standard. The detectability of the patent is straightforward as it will be part of the standard.

Integrating the RPCM mechanism into the existing protocol standards to ensure its widespread adoption and compatibility with current systems is also important. By incorporating the RPCM into the DCI fields, the mechanism can be seamlessly integrated into the communication protocol, allowing for efficient transmission of the configuration message from the gNb (next-generation Node B) to the UEs. This approach ensures that the RPCM mechanism can be easily detected and utilized by the UEs, leading to improved beamforming performance and overall system efficiency.

This disclosure highlights the significance of standardizing the RPCM mechanism within the 3GPP framework to facilitate its implementation and ensure its detectability as part of the communication protocol.

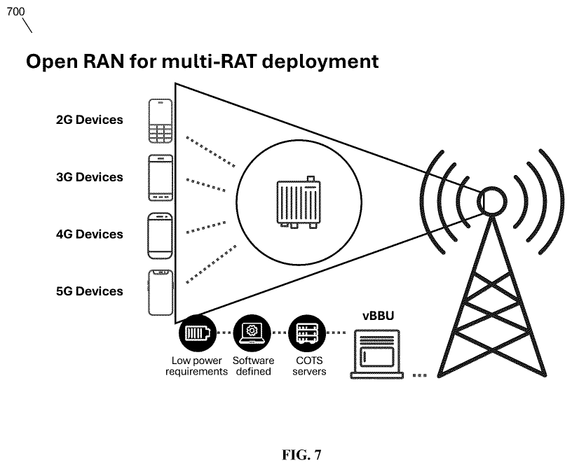

FIG. 7 is a schematic diagram of a multi-RAT RAN deployment architecture, in accordance with some embodiments. FIG. 7 shows a radio tower with a remote radio head (RRH) supporting multiple RATs, 2G/3G/4G/5G, but without requiring four generations of radio base stations on the tower. Instead, one or more software-upgradable, remotely configurable base stations is coupled to radio heads and filters that are able to operate on the appropriate frequencies for 2G, 3G, 4G, and 5G RATs. The multiple BBUs located at the bottom of the tower in the prior art have been replaced with one or more vBBUs, baseband units that are rearchitected to use modern virtualization technologies. FIG. 7 can be enabled using a technology like CPRI or eCPRI, which enables digitization and transfer of radio I/Q samples for further processing at a BBU or vBBU.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

In some embodiments, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7-2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (iFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU.

In some embodiments, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core.

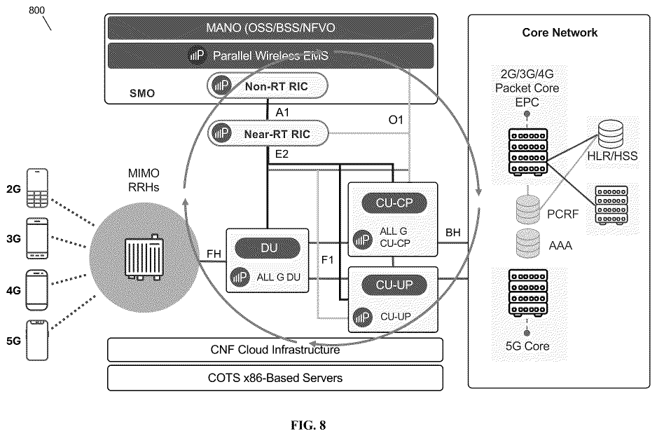

FIG. 8 is a further schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G. The all-G RRH plus DU/CU, i.e., the RAN portion of the diagram, are understood to be the components used to provide the functionality described hereinabove.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

In some embodiments, one or more of the following algorithms could be used to perform beamforming matrix calculations as described herein. The use of the gNB to calculate the beamforming matrix allows for the use of sophisticated algorithms that require more compute than are possible on the UE.

Minimum Mean Squared Error (MMSE): This algorithm minimizes the mean squared error between the desired and actual signal. It adapts the beamforming weights based on the received data to suppress interference and enhance the desired signal.

Zero-Forcing (ZF): The Zero-Forcing algorithm aims to completely eliminate interference by setting the beamforming weights such that the interference is nullified. This is achieved by inverting the channel matrix, which allows the transmitter to pre-cancel the interference.

Maximum Ratio Transmission (MRT): Also known as conjugate beamforming, MRT maximizes the signal-to-noise ratio (SNR) by aligning the beamforming weights with the channel state information (CSI). This method is simple and effective in scenarios with high SNR.

Eigen Beamforming: This algorithm uses the eigenvectors of the channel covariance matrix to determine the beamforming weights. It is particularly useful in scenarios with multiple users, as it can optimize the beamforming for each user independently.

Codebook-Based Beamforming: In this approach, a predefined set of beamforming vectors (codebook) is used. The optimal beamforming vector is selected from the codebook based on the CSI feedback from the user equipment (UE). This method reduces the complexity of beamforming weight calculation.

Adaptive Beamforming: This algorithm continuously adjusts the beamforming weights based on real-time feedback from the environment. Techniques such as Least Mean Squares (LMS) and Recursive Least Squares (RLS) are commonly used for adaptive beamforming.

Digital Beamforming: This method involves the use of digital signal processing techniques to calculate the beamforming weights. It allows for more flexibility and precision in beamforming, as the weights can be adjusted dynamically based on the channel conditions.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure. Various components in the devices described herein may be added, removed, or substituted with those having the same or similar functionality. Features of one embodiment may be used in another embodiment. Various steps as described in the figures and specification may be added or removed from the processes described herein, and the steps described may be performed in an alternative order, consistent with the spirit of the invention and the following claims.

1. A method for optimizing downlink beamforming in a massive MIMO transceiver system, comprising:
transmitting, by a next-generation Node B (gNb), a Rx Port Configuration Message (RPCM) to a User Equipment (UE), wherein the RPCM includes instructions for the UE to configure its receive (Rx) antennas to achieve a desired signal-to-interference ratio;
receiving, by the UE, the RPCM from the gNb;
configuring, by the UE, its Rx antennas based on the instructions provided in the RPCM;
performing, by the gNb, downlink beamforming based on the configuration of the UE's Rx antennas as indicated in the RPCM; and
achieving, by the system, improved spectral efficiency and overall system performance through the directed use of each of the UE's Rx antennas,
thereby improving Sounding Reference Signal (SRS) channel estimation, simplifying beamforming weight computation at the base station side, and enhancing cell throughput.

2. The method of claim 1, further comprising Rx antenna configuration for a UE that does not support full reciprocity for sounding signal transmission.

3. The method of claim 1, further comprising performing beamforming weight computation at the gNB using a Zero Forcing (ZF) precoder for interference cancellation at all active receive antennas of the UE.

4. The method of claim 1, wherein the RPCM includes at least one of an indication of antenna ports to use, an index to a predefined weight matrix, and an actual weights matrix.

5. A system for optimizing downlink beamforming in a massive MIMO transceiver system, comprising:
a next-generation Node B (gNb), the gNB further comprising a processor and a memory, the memory including instructions which, when executed on the processor at the gNB, cause the gNB to perform steps including:
performing beamforming weight computation using a User Equipment (UE) Sounding Reference Signal (SRS) for a plurality of UE receive (Rx) antennas at the UE;
transmitting a Rx Port Configuration Message (RPCM) to the UE, wherein the RPCM includes instructions on how the UE should configure the plurality of UE receive (Rx) antennas to achieve a desired signal-to-interference ratio; and
performing downlink beamforming based on the configuration of the UE's Rx antennas as indicated in the RPCM,
thereby achieving, by the system, improved spectral efficiency and overall system performance through the use of the plurality of UE Rx antennas at the UE.

6. The system of claim 5, the steps further comprising transmitting a RPCM message with Rx antenna configuration for a UE that does not support full reciprocity for sounding signal transmission.

7. The system of claim 5, the steps further comprising performing beamforming weight computation at the gNB using a Zero Forcing (ZF) precoder for interference cancellation at all active receive antennas of the UE.

8. The system of claim 5, wherein the RPCM includes at least one of an indication of antenna ports to use, an index to a predefined weight matrix, and an actual weights matrix.

9. The system of claim 5, the steps further comprising maintaining backward compatibility using Sounding Reference Signal (SRS) messaging with a second UE without RPCM compatibility.

10. A system for optimizing downlink beamforming in a massive MIMO transceiver system, comprising:
a user equipment (UE), the UE further comprising a processor and a memory, the memory including instructions which, when executed on the processor at the UE, cause the UE to perform steps including:
receiving, from a next-generation Node B (gNb), a Rx Port Configuration Message (RPCM), wherein the RPCM includes instructions on how the UE should configure each of a plurality of receive (Rx) antennas to achieve a desired signal-to-interference ratio; and
configuring each of the plurality of Rx antennas of the UE based on the instructions provided in the RPCM;
thereby improving Sounding Reference Signal (SRS) channel estimation, simplifying beamforming weight computation at the base station side, and enhancing cell throughput.

11. The system of claim 10, the steps further comprising receiving an RPCM message at the UE with an Rx antenna configuration for a UE that does not support full reciprocity for sounding signal transmission.

12. The system of claim 10, the steps further comprising receiving an RPCM message generated using a Zero Forcing (ZF) precoder for interference cancellation at all active receive antennas of the UE.

13. The system of claim 10, wherein the RPCM includes at least one of an indication of antenna ports to use, an index to a predefined weight matrix, and an actual weights matrix.
